(19) United States
(12) Patent Application Publication
(10) Pub. No.: US 2023/0385741 A1
(43) Pub. Date: Nov. 30, 2023

(54) MEETING ASSISTANCE METHOD AND MEETING ASSISTANCE DEVICE

(71) Applicant: Hitachi Solutions East Japan, Ltd., Sendai-shi (JP)

(72) Inventors: Takanari SEITO, Sendai-shi (JP); Tomoya TSUKAHARA, Sendai-shi (JP); Satoshi MUNAKATA, Sendai-shi (JP)

(73) Assignee: Hitachi Solutions East Japan, Ltd., Sendai-shi (JP)

(21) Appl. No.: 18/164,226

(22) Filed: Feb. 3, 2023

(30) Foreign Application Priority Data
May 26, 2022 (JP) 2022-086101

(51) Int. Cl. G06Q 10/0639; G10L 17/18; G10L 17/22; G10L 17/02

(52) U.S. Cl. CPC G06Q 10/06393; G10L 17/18; G10L 17/22; G10L 17/02

(57) ABSTRACT

A computer performs a meeting assistance method. The meeting assistance method comprises: obtaining speech data in a meeting; calculating a plurality of individual scores of the meeting based on the speech data; calculating a total score of the meeting based on the individual scores by using a trained neural network; calculating contribution degrees of respective individual scores with respect to the total score by using the trained neural network; and outputting information representing evaluation or advice for the meeting with respect to one or more of the individual scores based on the contribution degrees.

### CROSS REFERENCE TO RELATED APPLICATIONS

The present application claims priority from Japanese patent application JP 2022-086101 filed on May 26, 2022, the entire content of which is hereby incorporated by reference into this application.

### BACKGROUND

### Technical Field

The present application is related to meeting assistance method and meeting assistance device.

### Background Art

In meetings, it is desired to have active discussion within a short time and yield a result efficiently. In order to do so, it is important to recognize quality of meeting appropriately and facilitate the meeting so as to improve its quality.

However, facilitation is a difficult task which requires recognition of atmosphere or flow of the meeting, which is invisible. In particular, online meetings compose recent mainstream, and it is getting more difficult to perform appropriate facilitation in conditions wherein facial expressions or gestures of participants cannot be seen.

As a technique for assisting a meeting including facilitation, in JP 2021-163405 A, several scores (speaking duration, positive degree, negative degree, nodding count, etc.) constituting quality of meeting are defined and the quality of meeting is evaluated by their sum. Also, thresholds are defined for respective scores and an alert is displayed for the corresponding score item if a threshold is exceeded, in order to assist facilitation.

### SUMMARY

However, conventional techniques have a problem that it is difficult to perform appropriate facilitation depending on characteristics of a meeting.

There are various types of meeting, and meetings have respectively different appropriate evaluation methods of the quality or facilitation methods. In JP 2021-163405 A, the evaluation method for quality of meeting and the configured threshold are fixed, so they have to be adjusted to optimal values for each type of meeting. Accordingly, it is difficult to suggest facilitation appropriate in improving the quality of meeting.

For example, a factor for determining quality of meeting is imbalance degree of speakers. In a meeting for finding ideas, it is preferable to prompt many participants to speak by setting a threshold for speaker imbalance degree to be low. On the other hand, in a meeting for reporting, an opinion of a reporter is mainly discussed, so it is preferable to set the speaker imbalance degree to be higher than the meeting for finding ideas. Thus, in order for appropriate facilitation, it is preferable to recognize characteristics of the meeting.

An example of the present invention provides a meeting assistance method and a meeting assistance device which can perform appropriate facilitation assistance depending on characteristics of a meeting.

An example of a meeting assistance method related to the present invention is performed by a computer and comprises:
obtaining speech data in a meeting;
calculating a plurality of individual scores of the meeting based on the speech data;
calculating a total score of the meeting based on the individual scores by using a trained neural network;
calculating contribution degrees of respective individual scores with respect to the total score by using the trained neural network; and
outputting information representing evaluation or advice for the meeting with respect to one or more of the individual scores based on the contribution degrees.

In an example, the speech data includes:
information identifying a speaker;
text data representing content of the speech; and
information representing start time and end time of the speech.

In an example, a linear model approximating the trained neural network is used in calculating the contribution degrees.

In an example:
the total score;
at least one of the individual scores; and
the evaluation or text data representing the advice are displayed in outputting the information.

In an example, temporal changes in the meeting with respect to the total score and the at least one of the individual scores are displayed.

An example of a meeting assistance device related to the present invention comprises a computer that:
obtains speech data in a meeting;
calculates a plurality of individual scores of the meeting based on the speech data;
calculates a total score of the meeting based on the individual scores by using a trained neural network;
calculates contribution degrees of respective individual scores with respect to the total score by using the trained neural network; and
outputs information representing evaluation or advice for the meeting with respect to one or more of the individual scores based on the contribution degrees.

According to the present invention, appropriate facilitation assistance can be provided depending on characteristics of a meeting.

### BRIEF DESCRIPTION OF THE DRAWINGS

FIG. 1 is an overview of an example wherein a first embodiment of the present invention is applied;

FIG. 2 is an example of hardware construction of a meeting assistance device related to the first embodiment;

FIG. 3 is a flowchart representing an operation of the meeting assistance device of FIG. 2;

FIG. 4 is an exemplary format of speech data of FIG. 2;

FIG. 5 is an exemplary construction of a DNN related to the first embodiment;

FIG. 6 shows specific examples of alerts; and

FIG. 7 is a screen display example assuming an online meeting.

### DETAILED DESCRIPTION

Hereinafter, embodiments of the present invention will be described based on the drawings.

### First Embodiment

### 1. Overview of the Embodiment

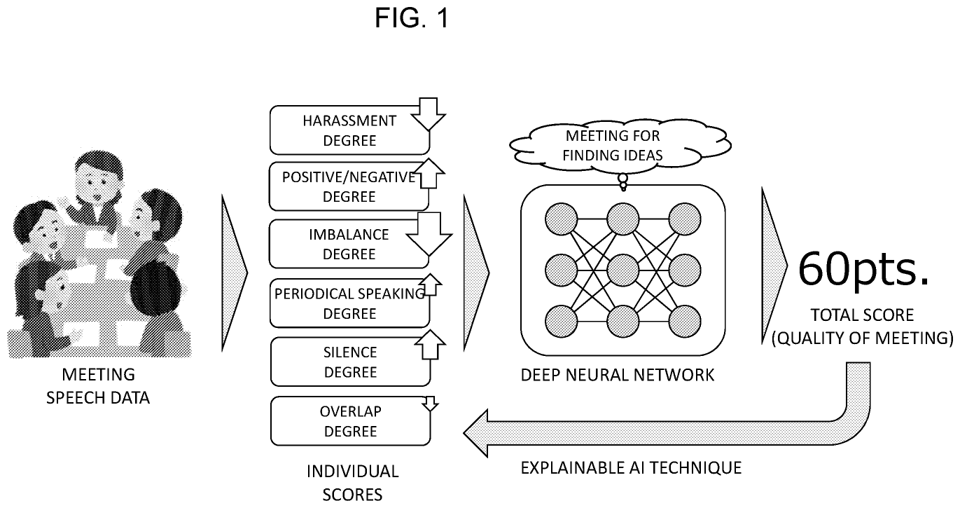

FIG. 1 shows an overview of an example wherein a first embodiment of the present invention is applied. A meeting assistance device related to the first embodiment comprises two functions, namely a function for determining quality of meeting and a function for assisting facilitation. The function for determining quality of meeting can be realized by using a DNN (Deep Neural Network) and the function for assisting facilitation can be realized by using XAI (eXplainable AI) technique.

The DNN can be constructed as a machine learning model which learns hidden features of input data based on a set of the input data and labeled output data and predicts output data based on the features. A DNN used in the present embodiment receives individual scores of meeting calculated based on speech data of the meeting as input, and outputs a total score (e.g. “60 points”) indicating quality of meeting. Hidden features including a type of the meeting or the like are extracted from the individual scores of the meeting and the quality of meeting can be determined by a method appropriate for each meeting.

XAI technique is used for the function for assisting facilitation. The XAI technique is a technique for understanding a ground of determination in a machine learning model. Although there are many types of the technique, a technique applied to the present embodiment presents contribution degrees of individual scores with respect to a total score as a ground for determination. In the present embodiment, facilitation of meeting is assisted by presenting an alert with respect to an individual score contributing to reducing quality of meeting in order to improve a value thereof. For example, if a contribution degree of “speech imbalance degree” is high in a direction for reducing the total score, an action for prompting a participant with low speaking frequency to speak is presented in order to reduce speech imbalance.

### 2. Global Image of the Embodiment

The meeting assistance device related to the present embodiment assists facilitation by a host (or a facilitator) of the meeting. Note that the present embodiment can be applied to both a face-to-face meeting and an online meeting. Details of operation is described later in <4. Flowchart>.

### 3. Hardware Construction

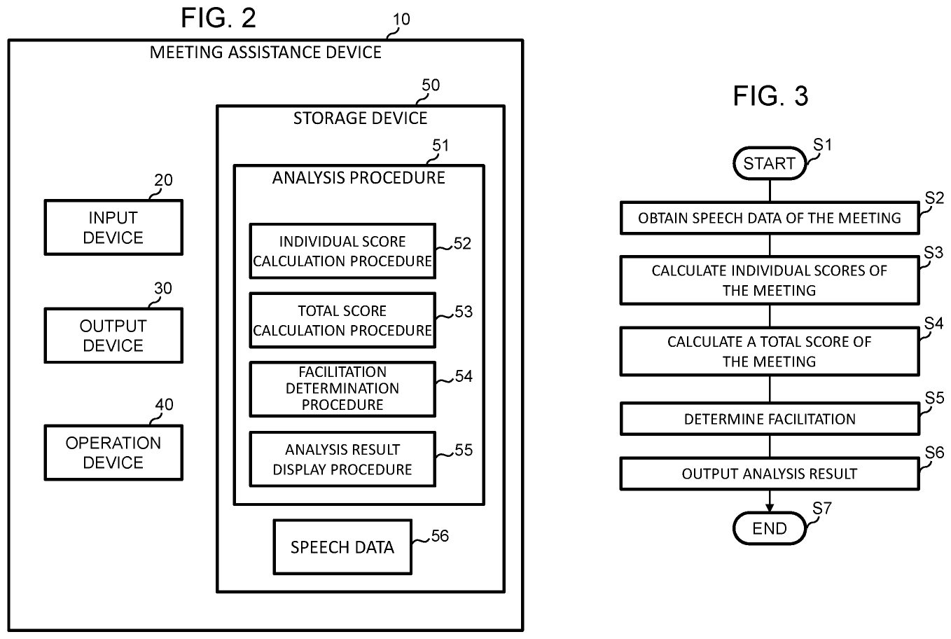

FIG. 2 is an example of hardware construction of a meeting assistance device 10 related to the present embodiment. This flowchart represents a meeting assistance method. The meeting assistance device 10 comprises an input device 20, an output device 30, an operation device 40 and a storage device 50.

The input device 20 obtains speech data (e.g. speech data 56 described later) of a meeting. The output device 30 outputs an analysis result. The operation device 40 executes a program stored in the storage device 50. The storage device 50 stores the program and other information.

The meeting assistance device 10 comprises a known computer. The input device includes, for example, input equipment (e.g. a keyboard, a mouse, a camera, a microphone, etc.) and a communication device (e.g. a network interface). The output device 30 includes, for example, output equipment (e.g. a display and a printer) and a communication device (e.g. the network interface). The operation device 40 includes, for example, a processor. The storage device 50 includes, for example, a storage medium (e.g. a semiconductor memory device and a magnetic disk device). The storage medium may be non-transitory.

Analysis procedure 51 is stored as a program in the storage device 50. The analysis procedure 51 includes individual score calculation procedure 52, total score calculation procedure 53, facilitation determination procedure 54 and analysis result display procedure 55. Details of the procedures will be described later. Also, the storage device 50 stores speech data 56.

A computer can be constructed so that it functions as the meeting assistance device and performs a meeting assistance method explained in the present embodiment by the operation device 40 executing the analysis procedure 51 stored in the storage device 50. In particular, the operation device 40 functions as individual score calculation means, total score calculation means, facilitation determination means and analysis result display means by performing the individual score calculation procedure 52, total score calculation procedure 53, facilitation determination procedure 54 and analysis result display procedure 55 respectively. Thus, the meeting assistance device 10 comprises a computer that performs the meeting assistance method related to the present embodiment.

### 4. Flowchart

FIG. 3 is a flowchart representing an operation of the meeting assistance device 10 related to the present embodiment. The meeting assistance device 10 as a computer performs the meeting assistance method related to the present embodiment by performing the process shown in FIG. 3.

The process of FIG. 3 can be started at any time instant within a meeting and can assist facilitation by a user with respect to progress of the meeting to that time instant. The user may use the process repeatedly until the meeting ends.

In Step S1, the meeting assistance device 10 starts the process of FIG. 3.

In Step S2, the meeting assistance device 10 obtains speech data in the meeting (e.g. the speech data 56 of the meeting stored in the storage device 50). Note that the meeting assistance device 10 may generate the speech data 56 independently of the process of FIG. 3. For example, the input device 20 may obtain the speech data 56 in real time. Also, the speech data 56 can be updated as the meeting progresses, and it is preferable to be updated for every time a speech is made.

A method for obtaining the speech data 56 can be designed in accordance with a format of the meeting as needed. For example, in a case of a face-to-face meeting, the input device 20 can obtain voice data from a voice input device such as a microphone installed at a meeting room and converts this to text data to generate the speech data 56. Also, in a case of an online meeting, the input device 20 can receive voice data, via communications network, obtained by client PCs of respective participants and converts this to text data to generate the speech data 56. Those skilled in the art can design a method for converting voice data to text data based on known techniques or the like as needed, and for example a so-called voice recognition technique can be used.

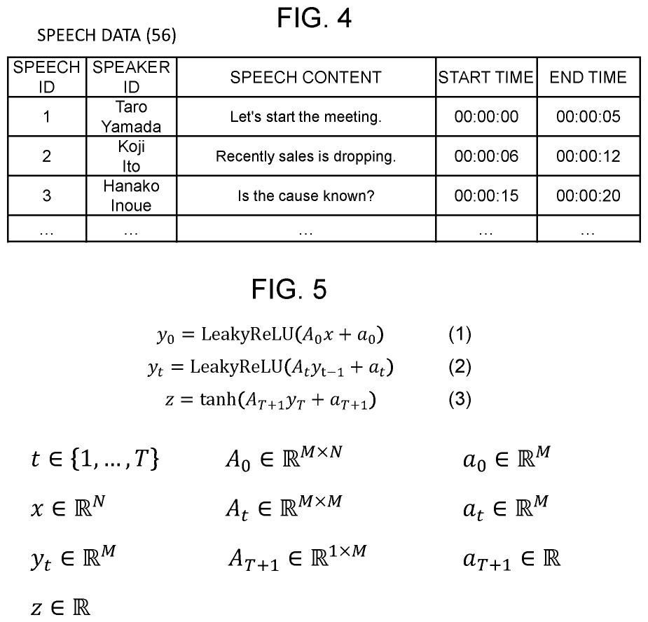

FIG. 4 shows an exemplary format of the speech data 56. The speech data 56 includes speech ID (information identifying the speech) as a key, speaker ID (information identifying the speaker), text data representing content of the speech and information representing start time and end time of the speech. The start time and the end time can be relative time instants with respect to the time instant at which the meeting started as 00:00:00. It is considered that a plurality of speakers speak at the same time, in which case time ranges of their speeches overlap at least partially.

Those skilled in the art can design a method for identifying a speaker ID for each speech (i.e. a method for distinguishing who is speaking) as needed. For example, a microphone may be provided for each participant and the participant may be associated with the microphone as a speaker. Also, a directional microphone can be used so that the speaker is identified based on a position or a direction of the speaker. Further, the speaker can be identified by using a voice recognition technique based on content of the voice (voiceprint or other features).

Upon obtaining the speech data 56 in Step S2, an entire portion of the speech data 56 related to the meeting may be obtained or data of latest predetermined period within the speech data 56 may be obtained. By using only the latest data, appropriate facilitation focusing on the latest condition of the meeting can be proposed.

In Step S3, the meeting assistance device 10 calculates a plurality of individual scores of the meeting based on the speech data 56 (individual score calculation procedure or individual score calculation step). The individual scores are, for example, values calculated regarding atmosphere or flow of the meeting, and details will be described later in <5. Individual Score Calculation Procedure>.

In Step S4, the meeting assistance device 10 uses a trained neural network to calculate a total score of the meeting based on the individual scores calculated in Step S3 (total score calculation procedure or total score calculation step). The total score is, for example, calculated as representing quality of meeting, and details will be described later in <6. Total Score Calculation Procedure>.

In Step S5, the meeting assistance device 10 determines content of facilitation for improving quality of meeting (facilitation determination procedure or facilitation determining step). Details will be described later in <7. Facilitation Determination Procedure>.

In Step S6, the meeting assistance device 10 outputs processing results (analysis results) of the above Steps S2-S5 at the output device 30 (analysis result display procedure or analysis result display step). The output is for example performed by displaying. Details will be described later in <8. Analysis Result Display Procedure>.

In Step S7, the meeting assistance device 10 terminates the process of FIG. 3.

### 5. Individual Score Calculation Procedure

In the individual score calculation procedure, individual scores related to atmosphere or flow of the meeting are calculated based on meeting data. An individual score is calculated for each of a plurality of items (individual score items) and the calculated value will be the individual score.

In the present embodiment, a harassment degree, a positive degree, a negative degree, an imbalance degree, a periodical speaking degree, a silence degree, and an overlap degree are used as individual score items. Details will be described below but those skilled in the art can modify definitions of the individual score items and calculation methods for the individual scores as needed.

The individual score item “harassment degree” is a degree indicating an extent as to how many speeches are made corresponding to harassment. A harassment degree is calculated for each speech and the maximum value among the harassment degrees for all the speeches is taken as the harassment degree of the meeting. In an alternative example, an average of the harassment degrees for the speeches may be taken as the harassment degree of the meeting. Also, the harassment degrees of the speeches may be represented in a histogram and the harassment degree of the meeting may be determined based on the histogram.

In an example, the harassment degree of each speech is a value within the range of 0 to 1 where 0 indicates that the harassment degree is low and 1 indicates that the harassment degree is high.

As to how the harassment degree of each speech is determined, for example, degrees corresponding to harassment are defined for particular words and it can be calculated based on these words included in speeches. However, such a definition might be difficult and it is preferable to determine by using a machine learning model.

For example, BERT, which is a recent mainstream of text analysis, may be used. BERT is a machine learning model that analyzes a text bidirectionally from the beginning and the end so that context can be understood. BERT per se is comprised by processes that vectorize words in the text and it performs various predictions using the vectorized words. In the present embodiment, it learns a method for determining harassment based on the vectorized words. A known trained model which learned a large amount of text data can be used for BERT. Accordingly, a method for determining harassment can be learned by a small amount of training data. Details of the model or methods of learning will not be described here because it is a known technique.

The individual score item “positive degree” is a degree indicating an extent to which positive speeches are made. Morphemes in text data of the speeches can be analyzed and a ratio of words defined to be positive among all the words can be taken as the positive degree. Morpheme analysis is a known technique, so descriptions therefor are omitted here. A known database can be used for a list of words defined to be positive.

The individual score item “negative degree” is a degree indicating an extent to which negative speeches are made. Morphemes in text data of the speeches can be analyzed and a ratio of words defined to be negative among all the words can be taken as the negative degree. Morpheme analysis is a known technique, so descriptions therefor are omitted here. A known database can be used for a list of words defined to be negative.

The individual score item “imbalance degree” is a degree indicating an extent to which the participants are speaking in a balanced manner. This is calculated by using a distance (e.g. a Euclidian distance) between a speech time vector and a center-of-gravity vector. The speech time vector is a vector wherein ratios of respective speech time of the participants with respect to the sum of the speech times of all the participants are listed. For example, a case is considered wherein the meeting has three participants and the sum of speech times of a first participant is T₁ minutes, the sum of speech times of a second participant is T₂ minutes and the sum of speech times of a third participant is T₃ minutes. In this case, the speech time vector is (T₁/T, T₂/T, T₃/T) where T=T₁+T₂+T₃. Also, the center-of-gravity vector is a vector wherein ratios of respective speech time of the participants in a case the participants spoke equally are listed. For example, if the meeting has three participants, the center-of-gravity vector is (1/3, 1/3, 1/3).

The individual score item “periodical speaking degree” is a degree indicating an extent as to how periodically the participants are speaking. For each participant, all pairs of two adjacent speeches of the participant are identified and a time interval between the speeches is calculated for each pair. Then, the maximum value among the time intervals of all the participants is taken as the periodical speaking degree of the meeting. Alternatively, a ratio of the maximum value to an entire duration for holding the meeting may be taken as the periodical speaking degree of the meeting. Note that, if only data of the latest predetermined period of the speech data 56 has been obtained in Step S2 instead of its entire amount, the duration of time range for the obtained speech data 56 may be used instead of the duration for holding the meeting (same hereinafter).

The individual score item “silence degree” is a degree indicating how much silent time was there. For example, a ratio of time wherein there was no speaker to an entire duration for holding the meeting is taken as the silence degree of the meeting.

The individual score item “overlap degree” is a degree indicting how much time was there wherein speeches were overlapping (i.e. the time wherein a plurality of participants were speaking simultaneously). A ratio of time wherein there were two or more speakers to an entire duration for holding the meeting is taken as the overlap degree of the meeting.

### 6. Total Score Calculation Procedure

In the total score calculation procedure, a DNN is used to calculate a total score indicating quality of meeting based on the individual scores. In the present embodiment, a fully connected model is applied as the DNN, but those skilled in the art may alter the construction of the DNN freely.

FIG. 5 shows an exemplary construction of a DNN related to the present embodiment. In FIG. 5: N is the number of individual score items; M is the number of feature amounts in the DNN; T is the number of layers of the DNN; t is a layer index of the DNN where 1≤t≤T; x is a vector wherein the individual scores are listed; y₀ and yₜ are vectors wherein the feature amounts are listed; z is a total score; A₀, Aₜ, A_{T+1} are weight parameters of the DNN; a₀, aₜ, a_{T+1} are bias parameters of the DNN; LeakyReLU is a leaky rectified linear unit; and tan h is a hyperbolic function.

Equation (1) converts an attribute vector comprising the individual scores into a feature amount vector including any number of elements. By applying Equation (2) repeatedly for every t, features of the meeting are extracted from the individual scores. Equation (3) calculates a value indicating a total score (e.g. a scalar value within a range of 0 to 1) based on the extracted feature amount vector. Here, for example, 0 indicates that the total score is low and 1 indicates that the total score is high.

By using the DNN, hidden features including a type of the meeting or the like can be extracted from the individual scores of the meeting and the quality of meeting can be determined based on the features by a method appropriate for each meeting. A method for learning the parameters of the DNN is a known technique, so explanation therefor is omitted here.

Those skilled in the art can also design as needed a method for generating training data used in the machine learning. For example, total scores are manually determined for various meetings in advance, and a plurality of individual scores are calculated based on speech data of the meetings, then a set of the calculated plurality of individual scores can be associated with the total score of the corresponding meeting and used as training data.

A format of the input/output data of the DNN is not limited to those described above. As an alternative example, the input data may include specific content of the speech (e.g. an element of vector representing a word).

### 7. Facilitation Determination Procedure

In the facilitation determination procedure, a XAI technique is used to determine facilitation for improving the quality of meeting. There are various types of XAI techniques, and LIME is used in the present embodiment. Other XAI techniques, such as ANCHOR or Grad-CAM, may be applied.

LIME is a technique for creating a linear model approximating a trained neural network in the vicinity of data with respect to which a ground of determination is desired and understanding contribution degrees of input items i to its prediction as a ground of determination. The linear model is for example f(x)=Σᵢ(wᵢxᵢ). Here, f(x) represents an approximated value of the total score outputted by the trained neural network and corresponds to z in Equation (3) of FIG. 5. xᵢ is a vector representing individual scores (where i is an index for the individual score items) and corresponds to x of FIG. 5. wᵢ is a vector (of the dimension same as xᵢ) representing the weight parameters.

Other XAI techniques (e.g. ANCHOR, Grad-CAM, etc.) can also determine wᵢ as well as LIME. XAI techniques are not limited to those for determining specific values such as wᵢ, and other XAI techniques which determine contribution degrees of respective individual scores to the total score in other formats can also be utilized. For example, the contribution degrees may be represented by ranking.

In this way, the meeting assistance device 10 calculates the contribution degrees of respective individual scores with respect to the total score by using the trained neural network in the facilitation determination procedure. Thus, it can be said that the facilitation determination procedure includes a contribution degree calculation step.

Here, the value of the weight parameter wᵢ corresponding to each individual score i can be taken as the contribution degree of the individual score. In particular, it can be said that the individual score item corresponding to the weight parameter (an element of wᵢ) whose absolute value is the greatest is the individual score item that contributed most to the total score. Also, the sign of a weight parameter indicates a direction of influence to a predicted value of the total score in the case the individual score changes. For example, if the sign is positive (or negative), increasing that item would increase (or decrease) the predicted value of the total score. A method for creating the linear approximation model is a known technique, so explanation therefor is omitted here.

In the present embodiment, weight parameters of the above linear approximation model are used to determine facilitation leading to improvement of the quality of meeting. First, with respect to a set of individual scores to be analyzed, a linear model approximating the trained model in the vicinity of the set is constructed. Next, the individual score item contributing most to prediction of the total score is identified. Then, regarding the individual score item, alert content for leading the individual score in a direction for increasing the total score is determined. As a specific example, if the weight is positive (+), an alert for increasing the value is proposed, and if the weight is negative (−), an alert for decreasing the value is proposed.

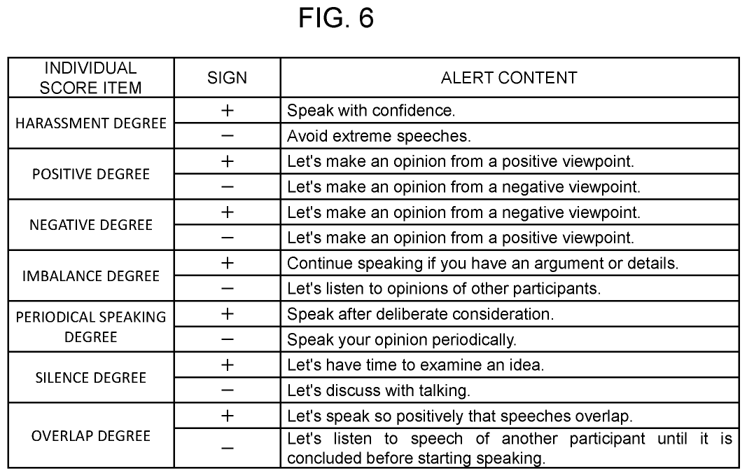

FIG. 6 shows specific examples of alerts. For example, in a case wherein the individual score item contributing most to the total score is “harassment degree” and the sign of the weight parameter corresponding to the harassment degree is negative, the alert content is “Avoid extreme speeches.” The alert content can be understood to be information representing an advice to the meeting. A user recognizing this information can prompt the participants to avoid extreme speeches. Also, the participants recognizing this information can make effort to avoid extreme speeches subsequently. This reduces the harassment degree of the meeting so that the quality of meeting is improved.

Note that, the individual score item “harassment degree” in the present embodiment does not immediately mean that there was unacceptable harassment, so the quality of meeting would not necessarily be higher when its individual score is low. For example, if speeches become passive for excessive fear of harassment, the quality of meeting might rather be lower. In such a case, alert content would be “Speak with confidence.”.

Thus, the present embodiment is not intended to maintain the individual score items always high or always low, but makes it possible to move the individual scores closer to respective appropriate values. However, as an alternative example, it is also possible to construct so that the individual score items are maintained to be always high or always low.

### 8. Analysis Result Display Procedure

In the analysis result display procedure, results of data analysis performed in Steps S2-S5 are outputted at the output device 30 of the meeting assistance device 10. The output may be performed by displaying on a screen of the meeting assistance device 10, by transmitting to another computer or by storing in the storage device 50. If it is done by transmitting to the other computer, for example, the transmission may be done to client PCs operated by the participants and the transmitted data may be displayed on screens of the client PCs.

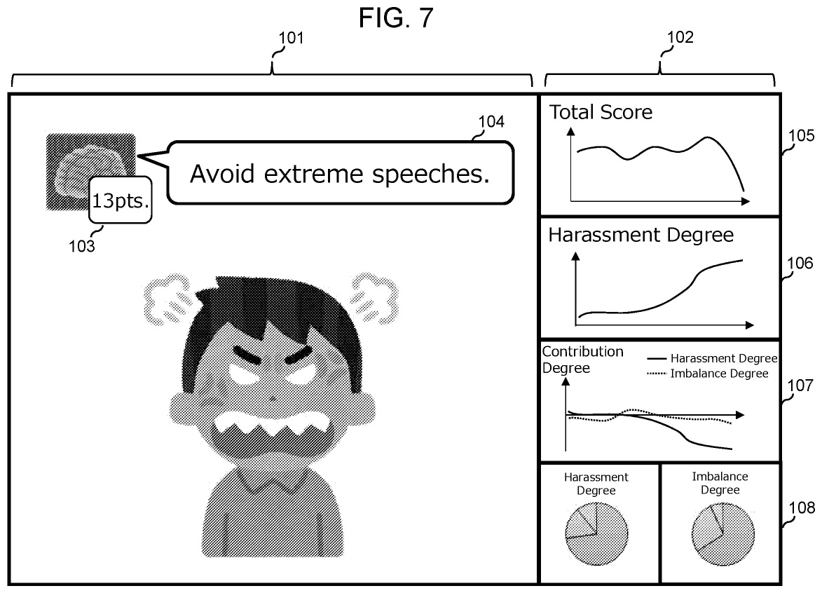

FIG. 7 shows a screen display example assuming an online meeting. The displayed screen includes a main space 101 for mainly displaying a face of a participant (e.g. captured by a camera) and/or materials of the meeting and an analysis space 102 for displaying analysis content.

A total score 103 and alert content 104 are displayed at a top portion of the main space 101. Note that, in this example, although the total score 103 is converted into a value suitable for display (for example, a value of 100 times z in FIG. 5 is displayed), this is equivalent to displaying the total score per se.

Thus, the meeting assistance device 10 outputs the alert content with respect to one of the individual scores based on the contribution degrees of respective individual scores in the analysis result display procedure. That is, it can be said that the analysis result display procedure includes an outputting step. Note that, although the alert content is outputted for only a single individual score item in the example of FIG. 7, the alert content may be outputted with respect to a plurality of individual score items.

Other analysis results are displayed in the analysis space 102. The analysis space 102 includes, for example, a total score display area 105 for displaying the total score, an individual score display area 106 for displaying an individual score, a contribution degree display area 107 for displaying contribution degrees of the individual scores and summarization area 108 for displaying a summarization result of individual scores for each participant.

It may be constructed that the analysis space 102 can be switched in response to an operation so that it is not displayed and does not disturb progress of the meeting.

The analysis results may be displayed as time-series data as in the total score display area 105, the individual score display area 106 and the contribution degree display area 107 in the example of FIG. 7. In particular, the example of FIG. 7 displays temporal changes in the meeting with respect to the total score and at least one individual score (i.e. the harassment degree).

On the other hand, only the latest result may be displayed and updated in real time as in the total score 103, the alert content 104 and the summarization area 108 in the example of FIG. 7. The total score 103 and the alert content 104 may be updated every time a new analysis result is obtained (for example, every time Steps S2-S5 are performed).

Of course, any of the total score 103, the alert content 104 and the summarization area 108 may display time-series data and any of the total score display area 105, the individual score display area 106 and the contribution degree display area 107 may display only the latest result.

The individual score display area 106 may display a single individual score whose absolute value is greatest as in the example of FIG. 7 or may display a plurality of individual scores in a descending order of the absolute values of the contribution degrees. For example, FIG. 7 displays the harassment degree which has the greatest absolute value of the contribution degree. Although only the harassment degree is shown in FIG. 7 for spatial reasons, all the individual scores may be displayed.

If the individual score display area 106 displays a plurality of individual scores, sizes of display may be changed in response to the contribution degrees, for example an individual score with a small absolute value of the contribution degree is displayed smaller.

The analysis results may be displayed after being summarized for each participant or each section to which participants belong. For example, the summarization area 108 of FIG. 7 displays pie charts wherein the harassment degrees and the imbalance degrees are respectively summarized for the participants. Those skilled in the art can design a method for summarization as needed. For example, regarding the harassment degree, the harassment degrees may be calculated for respective participants (not for the entire meeting) and a ratio of the harassment degrees among the participants may be displayed in a pie chart. Also, regarding the imbalance degree, a ratio of respective elements of the speech time vector used for calculating the imbalance degree of the meeting may be displayed in a pie chart.

Regarding the alert, if there are a plurality of display device (for example, it can be displayed at client PCs of respective participants), each display device may be controlled as to whether the alert content 104 is to be displayed. For example, if an alert is issued regarding the harassment degree, the alert may be displayed only to the participant who made the speech with the highest harassment degree.

If the total score, at least one individual score and the alert content are displayed as in the example of FIG. 7, the individual score item which is problematic and a degree of the problem can be grasped easily based on the alert content. However, FIG. 7 is a mere example of combination for display content and those skilled in the art can modify the combination of displayed content as needed.

In the present embodiment, the alert content represents an advice for the meeting. However, it may represent mere evaluation of the meeting. For example, if the harassment degree is large, text data such as “Extreme speeches are increasing.” can be outputted.

### 9. Utilization Example

An application example for the meeting assistance device 10 related to the present embodiment is explained below. The host of the meeting examines facilitation in the meeting by using the meeting assistance device 10. For example, the host recognizes that quality of the meeting is decreasing at any timing of the meeting with reference to the total score 103 of the meeting and the time-series display in the total score display area 105 at that time, and understands that facilitation for improving the quality of meeting is necessary.

In consideration of facilitation, the host identifies the element (the individual score item) that affects the quality of meeting with reference to the individual score displayed in the individual score display area 106 and its contribution degree displayed in the contribution degree display area 107. In the example of FIG. 7, the absolute value of the contribution degree of the harassment degree is the greatest and its sign is negative, so it can be found that facilitation for reducing the harassment degree is desired.

Further, the host examines whom the host should prompt to pay attention specifically, based on the harassment degrees of respective participants displayed in the summarization area 108. Finally, the host prompts the participant to pay specific attention based on the displayed alert content 104.

As explained above, according to the meeting assistance method and the meeting assistance device 10 related to the first embodiment, appropriate facilitation assistance can be performed depending on characteristics of a meeting.

### DESCRIPTION OF SYMBOLS

10 Meeting assistance device
20 Input device
30 Output device
40 Operation device
50 Storage device
51 Analysis procedure
52 Individual score calculation procedure
53 Total score calculation procedure
54 Facilitation determination procedure
55 Analysis result display procedure
56 Speech data
101 Main space
102 Analysis space
103 Total score
104 Alert content (information representing evaluation or advice)
105 Total score display area
106 Individual score display area
107 Contribution degree display area
108 Summarization area

What is claimed is:

1. A meeting assistance method performed by a computer, comprising:
obtaining speech data in a meeting;
calculating a plurality of individual scores of the meeting based on the speech data;
calculating a total score of the meeting based on the individual scores by using a trained neural network;
calculating contribution degrees of respective individual scores with respect to the total score by using the trained neural network; and
outputting information representing evaluation or advice for the meeting with respect to one or more of the individual scores based on the contribution degrees.

2. The method according to claim 1, wherein the speech data includes:
information identifying a speaker;
text data representing content of the speech; and
information representing start time and end time of the speech.

3. The method according to claim 1, wherein a linear model approximating the trained neural network is used in calculating the contribution degrees.

4. The method according to claim 1, wherein:
the total score;
at least one of the individual scores; and
the evaluation or text data representing the advice are displayed in outputting the information.

5. The method according to claim 4, wherein temporal changes in the meeting with respect to the total score and the at least one of the individual scores are displayed.

6. A meeting assistance device, wherein the meeting assistance device comprises a computer that:
obtains speech data in a meeting;
calculates a plurality of individual scores of the meeting based on the speech data;
calculates a total score of the meeting based on the individual scores by using a trained neural network;
calculates contribution degrees of respective individual scores with respect to the total score by using the trained neural network; and
outputs information representing evaluation or advice for the meeting with respect to one or more of the individual scores based on the contribution degrees.
